(19) United States
(12) Patent Application Publication
(10) Pub. No.: US 2016/0006642 A1
(43) Pub. Date: Jan. 7, 2016

(54) NETWORK-WIDE SERVICE CONTROLLER

(71) Applicant: NATIONAL TSING HUA UNIVERSITY, HSINCHU (TW)

(72) Inventors: SHIH YU CHANG, HSINCHU (TW); YU PING JANG, HSINCHU (TW); TIN WEI LIN, HSINCHU (TW)

(21) Appl. No.: 14/324,684

(22) Filed: Jul. 7, 2014

(51) Int. Cl. H04L 12/751; H04L 12/26; H04L 12/46; H04L 12/803

(52) U.S. Cl. CPC H04L 45/02; H04L 47/125; H04L 43/0876; H04L 12/4641

(57) ABSTRACT

A network-wide service controller comprises a monitoring device, an intelligent device, and a management device. The monitoring device is configured to monitor a state of at least one network. The intelligent device is configured to determine a path within the at least one network according to the state of the at least one network. The intelligent device is further configured to receive an instruction from a user and convert the instruction into a lower-level instruction. The management device is configured to analyze the lower-level instruction from the intelligent device and control forwarding of packets according to a result of analysis of the lower-level instruction and the path determined by the intelligent device.

### BACKGROUND

1. Technical Field

The present invention relates to a network-wide service controller.

2. Related Art

Cloud computing provides dynamically scalable and virtualized resources over the Internet. Cloud computing enables convenient, on-demand network access to a shared pool of configurable computing resources, e.g., networks, servers, storage, applications, and services. Cloud computing is often described as a stack, which includes Software as a Service (SaaS), Platform as a Service (Paas), and Infrastructure as a Service (IaaS). SaaS allows users to run applications remotely. IaaS includes virtualized computers with guaranteed processing power and reserved bandwidth for storage and Internet access. PaaS is similar to IaaS, but includes operating systems and required services for a particular application.

Moving successfully into cloud computing requires an architecture that can support the cloud capabilities. Since SOA (Service Oriented Architecture) allows user front-end applications and enterprise back-end services to easily access cloud services, SOA provides a popular architecture that is applied in clouds.

A computing process in cloud computing may run on one or many connected computers at the same time, utilizing the concept of virtualization. With virtualization, one or more physical servers can be configured and partitioned into multiple independent virtual machines, all functioning independently and appearing to users to be a single physical device. Such virtual machines do not physically exist and can be moved around and scaled up or down on the fly. However, usually when a virtual machine is migrated from one physical server to another physical server, the firewall of another physical server is not changed accordingly, resulting in security issues.

Virtualized networking architectures may be provided and underlie services of cloud computing so as to eliminate the complex and static nature of legacy distributed network architectures. However, such virtualized networking architectures have some disadvantages: they are monolithic and do not have clearly defined user interfaces and application concepts; the virtualized networking architectures include software stacks, which have to be completely updated when a new function is added; and many problems are created after every update.

### SUMMARY

In some embodiments, a network-wide service controller comprises a monitoring device, an intelligent device, and a management device. The monitoring device is configured to monitor a state of at least one network. The intelligent device is configured to determine a path within the at least one network according to the state of the at least one network. The intelligent device is further configured to receive an instruction from a user and convert the instruction into a lower-level instruction. The management device is configured to analyze the lower-level instruction from the intelligent device and control forwarding of packets according to a result of analysis of the lower-level instruction and the path determined by the intelligent device.

In some embodiments, a network-wide service controller comprises a processor and a memory coupled to the processor. The memory stores an integrated set of instructions. The processor is configured to perform the integrated set of instructions so as to monitor a state of at least one network, perform path computation according to the state of the at least one network, convert an instruction from a user to a lower-level instruction, analyze the lower-level instruction, and control forwarding of packets according to results of analysis of the lower-level instruction and the path computation.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 schematically demonstrates an application of a network-wide service controller according to one embodiment of the present invention;

FIG. 2 is a schematic view showing a network-wide service controller in according to one embodiment of the present invention;

FIG. 3 is a schematic view showing a monitoring device according to one embodiment of the present invention;

FIG. 4 is a schematic view showing an intelligent device according to one embodiment of the present invention;

FIG. 5 is a schematic view showing a management device according to one embodiment of the present invention;

FIG. 6 is a schematic view showing a network-wide service controller according to another embodiment of the present invention; and

FIG. 7 is a diagram showing a method of delivering a combined service according to one embodiment of the present invention.

### DETAILED DESCRIPTION OF DISCLOSED EMBODIMENTS

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

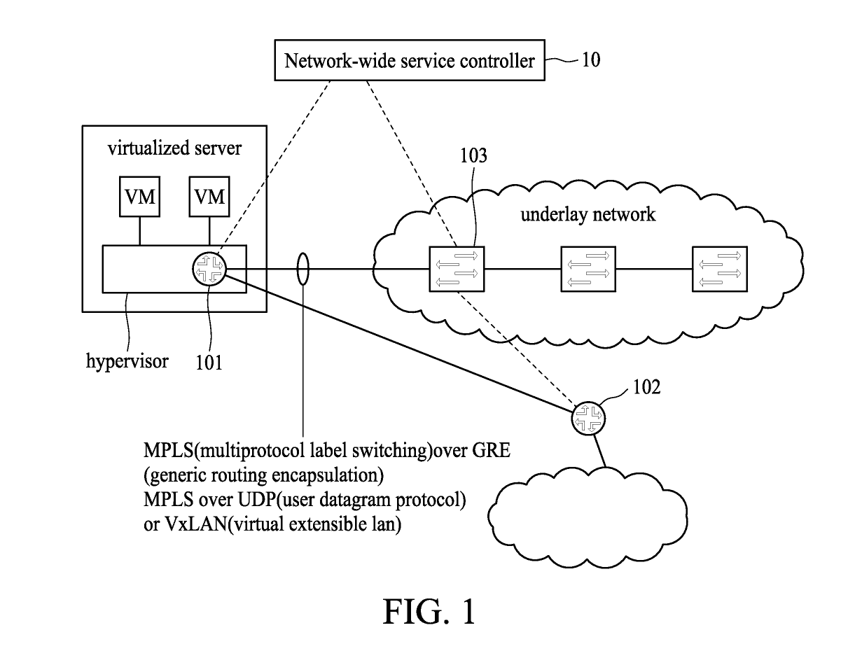

FIG. 1 schematically demonstrates an application of a network-wide service controller 10 according to one embodiment of the present invention. Referring to FIG. 1, a network-wide service controller 10 is configured to manage at least one network. The network-wide service controller 10 is in configured to perform control (which is separated from the switching hardware) over how data is forwarded to its destination. The network-wide service controller 10 can provide an abstract, centralized view of the overall network. The network-wide service controller 10 allows users to quickly and easily make and push out decisions on how the underlying devices or systems (switches or routers) of the forwarding plane will handle the traffic.

The network-wide service controller 10 can include a protocol that allows the controller 10 to define how packets are forwarded. In some embodiments, the protocol is an open protocol, such as, but not limited to, OpenFlow. Moreover, the network-wide service controller 10 provides programmable central control of network traffic without requiring physical access to the network's switches or routers. The network-wide service controller 10 can connect to at least one physical network and communicate with network hardware through gateways that use a standard set of protocols. The gateways can collect data on the physical network and enable service chains for Layers 4-7 network services and security.

In some embodiments, the network-wide service controller 10 allows users to shape traffic and deploy services to address changing business needs without having to touch each individual switch or router in the forwarding plane. In some embodiments, the network-wide service controller 10 comprises an SDN (software-defined networking) based controller.

In some embodiments, the network-wide service controller 10 is included in a control plane, interfaces with data plane switches, and enforces packet treatment rules on data plane switches.

In some embodiments, the network-wide service controller 10 is applied in an architecture targeting layer 2 and layer 3 infrastructure components.

In some embodiments, the network-wide service controller 10 can use multiple VNFs (virtualized network functions) in sequence to deliver a service to a user. The VNFs can be located in all possible locations, from a data center to a network node to customer premises. The network-wide service controller 10 can attach at least service to individual flows or groups of flows (i.e., aggregate flows). The network-wide service controller 10 can define the elements and the ordering and configurations required to implement a service. Services may be implemented in a machine with multiple/compartmentalized OS(s), within a hypervisor, as distributed or clustered as composites, on bare metal machines, or virtual containers. Services may be naturally associated with network boundaries, for example, by attaching a security policy to a network boundary. The network boundary may be a boundary between a tenant network and an external network (the Internet or the VPN to an enterprise network), the network of one tenant and the network of another tenant, or multiple networks of the same tenant.

The network-wide service controller 10 can apply services to flows of traffic by defining the elements and the ordering and configurations required to implement a service, identifying and steering the flow of traffic to visit the service node or the sequence of service nodes, and signaling to the service nodes to inform them which services to apply to which flows including the service parameters.

Referring to FIG. 1, the network-wide service controller 10 is configured to communicate with virtual network elements 101 (including vRouters) or physical network elements (including gateway routers 102 and switches 103). The interface of the network-wide service controller 10 for vRouters may be, but is not limited to, XMPP (extensible messaging and presence protocol). The interface of the network-wide service controller 10 for gateway routers 102 and switches 103 may be, but is not limited to, BGP (board gateway protocol) and NETCONF (network configuration protocol).

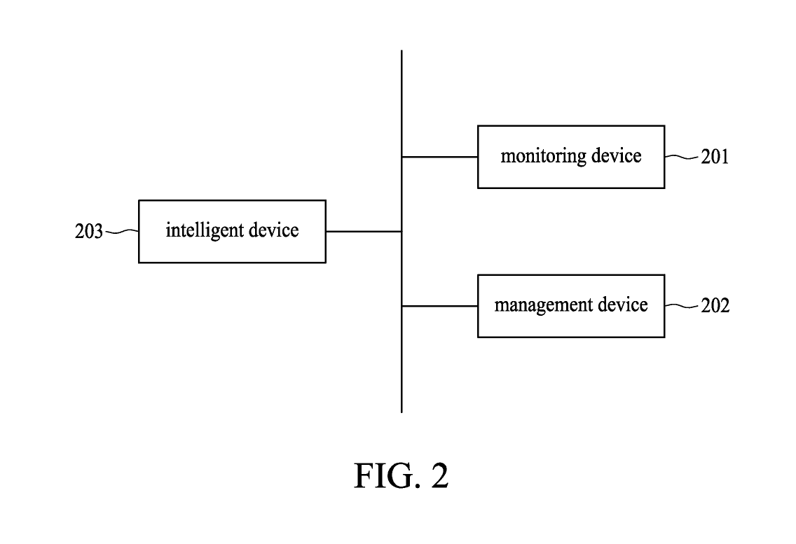

FIG. 2 is a schematic view showing a network-wide service controller 10 according to one embodiment of the present invention.

The network-wide service controller 10 is a hardware controller or a computer-implemented application. The network-wide service controller 10 includes a monitoring device 201, a management device 202, and an intelligent device 203. The monitoring device 201, the management 202, and the intelligent device 203 can be connected with each other, or only the ones that need to communicate are connected. The monitoring device 201, the management 202, and the intelligent device 203 can use a bus to communicate, but the present invention is not limited to such an embodiment.

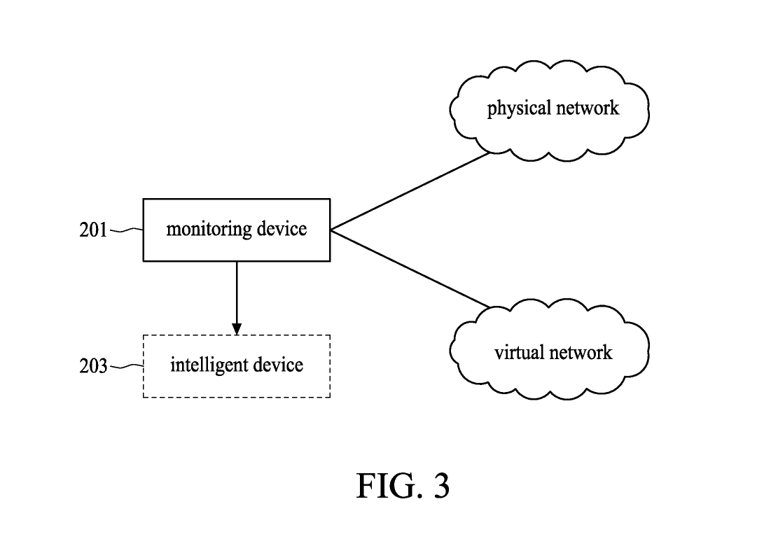

Referring to FIGS. 2 and 3, the monitoring device 201 is configured to monitor a state of at least one network, a physical network, a virtual network, a wired network, a wireless network, a corporate LAN, VPN (virtual private network), or service provider WAN. The monitoring device 201 may discover applications, networks, and servers/systems on start-up. The monitoring device 201 can discover the relationships between different L2/L3 devices using technologies such as CDP (cisco discovery protocol), DHCP (dynamic host configuration protocol), arp (address resolution protocol), icmp (internet control message protocol) and route tables. The state of a network may include the location and connectivity of the nodes and links, the physical propagation delays of the links, the security posture of every node and link, and the available bandwidth at the links. The monitoring device 201 is configured to send monitoring results and states of networks to the intelligent device 203.

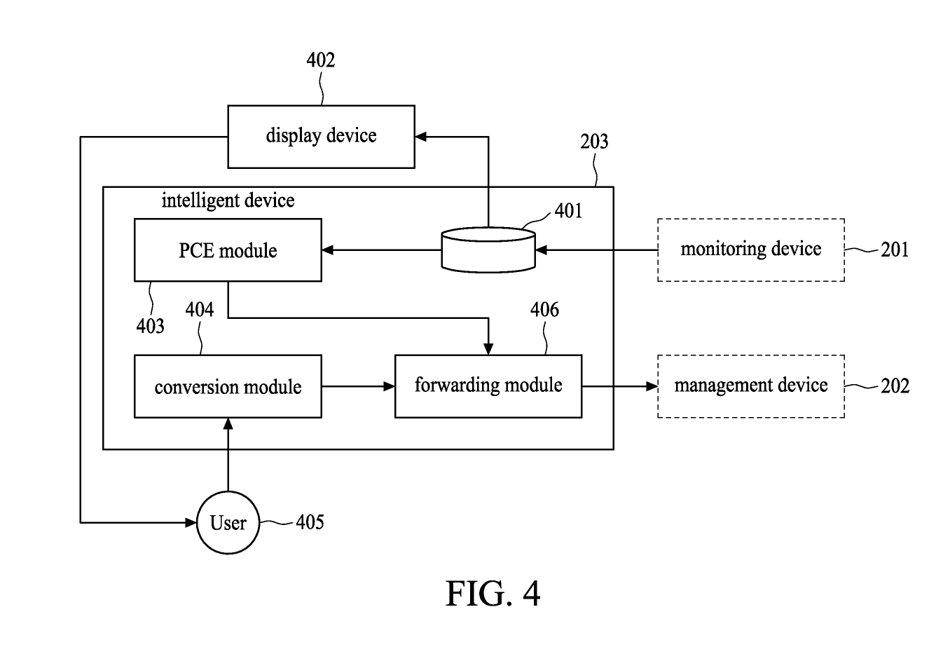

Referring to FIG. 4, the intelligent device 203 is configured to determine a path for forwarding packets within the at least one network according to the state of the network. The intelligent device 203 can determine a suitable or best path according to at least one metric used by routing protocols. The metric may include hop count or bandwidth, but the present invention is not limited to the afore-mentioned metrics.

In some embodiments, the network-wide service controller 10 or the intelligent device 203 uses the state of network to construct at least one topology map between network devices, such as switches, routers, VLANs, atm (asynchronous)/frame-relays, and bridges and hubs. The topology may include a physical network topology, a virtual network topology, or both. The topology discovery may include Layer 2 and Layer 3 discoveries.

Referring to FIG. 4, the intelligent device 203 is configured to receive data of the state of the at least one network and store data in a storage 401, which can be deployed in the intelligent device 203 or the network-wide service controller 10, for later analysis. The storage 401 may be coupled with a display device 402 which can be used to show the state of the at least one network to users. The storage 401 may be an optical, magnetic, semiconductor, or electronic storage.

The intelligent device 203 may include a PCE (path computation element) module 403, which can be coupled with the storage 401 and retrieve network state data from the storage 401 to determine a suitable or best path for forwarding packets. In some embodiments, path computation can either be performed using a centralized path computation element or a distributed routing protocol. In the former case, the PCE module 403 may try to optimize the traffic placement by taking into account the network resources, topology and estimated traffic matrix along with other parameters and objectives. Alternatively, the distributed routing protocols rely on a distributed control plane where routers exchange routing information (routes, topological data, etc.) to compute their routing tables.

Referring to FIG. 4, the intelligent device 203 can include a conversion module 404 that can receive an instruction or request for network actions from a user 405 and convert the instruction or request to low-level instruction or information for implementation via control code.

The intelligent device 203 can include a forwarding module 406. The forwarding module 406 can be coupled with the conversion module 404 so as to send the low-level instruction or converted information to the management device 202. The forwarding module 406 may be further coupled with the PCE module 403 so as to receive a result (a suitable path of path computation) from the PCE module 403 and send it to the management device 202.

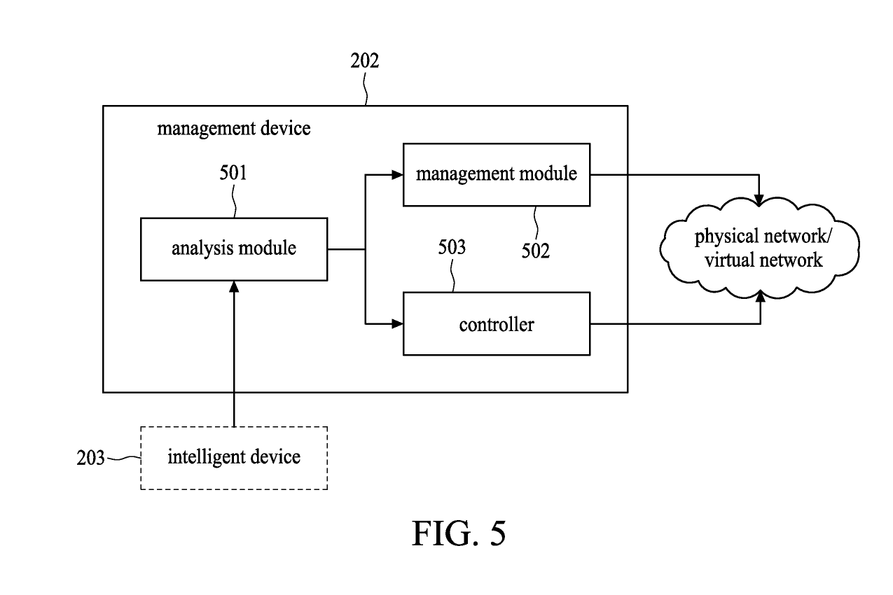

FIG. 5 is a schematic view showing a management device 202 according to one embodiment of the present invention.

The management device 202 may include an analysis module 501 that is configured to receive the low-level instruction or converted information from the intelligent device 203 and analyze the low-level instruction or converted information. Then, the analyzed result is sent to a management module 502 and a controller 503 both included in the management device 202.

The management module 502 may be coupled with a physical network, a virtual network, or both. Users can provide instructions for the intelligent device 203 so as to perform, for example, security, caching and bandwidth management through the management module 502 on a physical network, a virtual network, or both.

The controller 503 is coupled with a physical network, a virtual network, or both. The controller 503 is configured to control functions of networking devices, such as routers, packet switches, and LAN switches. The controller 503 is configured to manage the forwarding state of networking devices. The controller 503 is configured to communicate with networking devices through suitable routing protocols so as to change their routing tables according to the path determined by the PCE module 403 of the intelligent device 203 such that relevant data packets can be forwarded according to the path and the result of analysis of the low-level instruction or converted information.

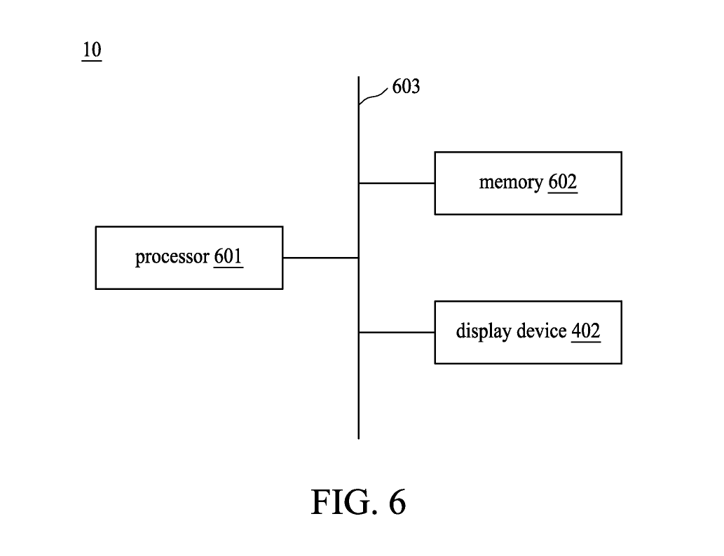

FIG. 6 is a schematic view showing a network-wide service controller 10 according to another embodiment of the present invention.

The network-wide service controller 10 coupled with at least one network may include a processor 601 and a memory 602. The processor 601 and the memory 602 can be coupled with each other via, for example, a bus 603. The processor 601 is a hardware that can carry out instructions stored in the memory 602. The memory 602 can be volatile or non-volatile. The memory 602 can store an integrated set of instructions, and the processor 601 performs the integrated set of instructions to monitor a state of at least one network and perform path computation according to the state of the at least one network so as to determine a suitable path for forwarding corresponding packets. The processor 601 can perform the integrated set of instructions in order to receive an instruction or request from a user and convert the instruction to a lower-level instruction or information. The lower-level instruction is an instruction acceptable to networking devices. The processor 601 can further perform the integrated set of instructions in order to analyze the lower-level instruction or information, and control the forwarding of the corresponding packets according to the result of analysis of the lower-level instruction or information and the suitable path. The network-wide service controller 10 can connect to a display device 402 so as to show network states stored in a storage.

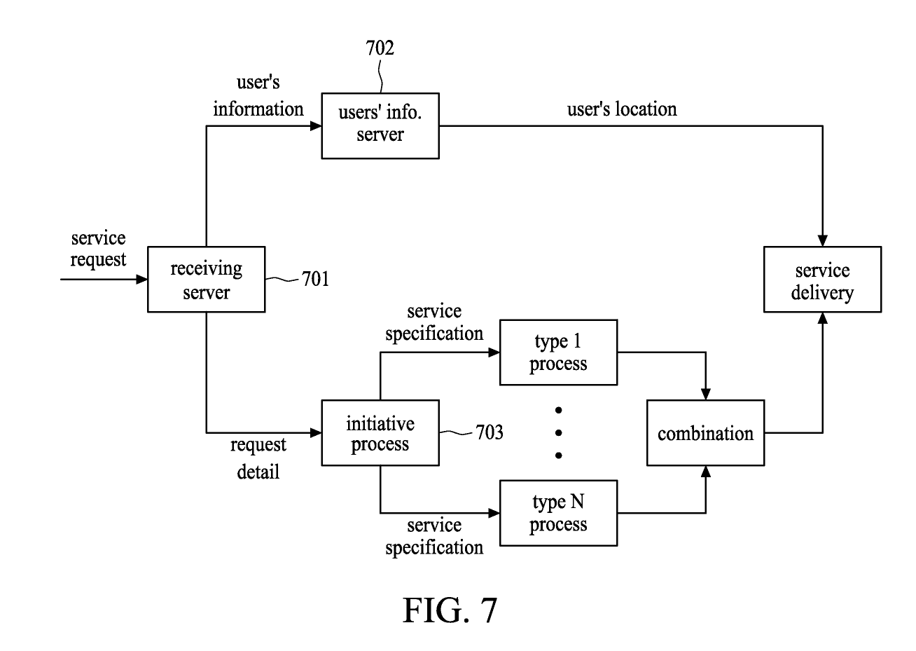

FIG. 7 is a diagram showing a method of delivering a combined service according to one embodiment of the present invention.

Referring to FIG. 7, in some embodiments, the network-wide service controller 10 enables applications to request and manipulate services provided by a network. The network-wide service controller 10 can compose a network service that can meet the requirements of a particular application according to a request from a user. The network-wide service controller 10 can include a receiving server 701 which is configured to receive a service request and parse the request to determine the user's information and request details. The receiving server 701 is further configured to send the user's information to a users' information server 702 included in the network-wide service controller 10 and send the request details to an initiative process. The users' information server 702 included in the network-wide service controller 10 can at least determine a user location and other required information according to the user's information. The initiative processor or process 703 included in the network-wide service controller 10 can determine service specifications in the request details and accordingly selects or imports corresponding processes from at least one network. The selected processes are then combined and delivered with the user location information.

In some embodiments, the network-wide service controller 10 connects to networks and is configured to coordinate services distributed over the networks so as to satisfy users' requirements. In some embodiments, the management device 202 and/or the intelligent device 203 can be configured to coordinate services distributed over the networks.

In some embodiments, the network-wide service controller 10 can be used to build a plurality of virtual environments and may be further configured to deploy a load balancer between the plurality of virtual environments. In some embodiment, the management device 202 and/or the intelligent device 203 can be configured to build a plurality of virtual environments and may be further configured to deploy a load balancer between the plurality of virtual environments.

In some embodiments, the network-wide service controller 10 may be configured to optimize load balancing between computing resources, such as computers, a computer cluster, network links, central processing units or disk drives, so as to properly distribute workloads across the computing resources. In some embodiment, the management device 202 and/or the intelligent device 203 can be configured to optimize load balancing between computing resources.

In some embodiments, the network-wide service controller 10 can provide different firewall services with different security requirements according to system requirements or security policies. In some embodiments, when a virtual machine is migrated from a computing environment to another computing environment employing a firewall service different from that of the previous computing environment, the network-wide service controller 10 can provide the same firewall service of the previous computing environment for the migrated virtual machine after migration so that the virtual machine can be protected by using the same suitable firewall service, wherein its security will not be compromised after it is migrated in a computing environment employing a less secure firewall. In some embodiment, the management device 202 and/or the intelligent device 203 can be configured to provide different firewall services with different security requirements according to system requirements or security policies.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code, and stored within the non-transitory computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within to the hardware modules.

It will be apparent to those skilled in the art that various modifications and variations can be made to the disclosed embodiments. It is intended that the specification and examples be considered as exemplary only, with a true scope of the disclosure being indicated by the following claims and their equivalent.

What is claimed is:

1. A network-wide service controller, comprising:
a monitoring device configured to monitor a state of at least one network;
an intelligent device configured to determine a path within the at least one network according to the state of the at least one network, the intelligent device further configured to receive an instruction from a user and convert the instruction into a lower-level instruction; and
a management device configured to analyze the lower-level instruction from the intelligent device and control forwarding of packets according to a result of analysis of the lower-level instruction and the path determined by the intelligent device.

2. The network-wide service controller of claim 1, wherein the intelligent device is configured to perform a path computation to determine the path.

3. The network-wide service controller of claim 1, further comprising a storage, wherein the intelligent device is configured to store data of the state of the at least one network in the storage for analysis.

4. The network-wide service controller of claim 1, further configured to compose a service by combining processes.

5. The network-wide service controller of claim 1, further configured to coordinate distributed services over the at least one network.

6. The network-wide service controller of claim 1, configured to be used for building a plurality of virtual environments.

7. The network-wide service controller of claim 5, configured to be used for deploying a load balancer between the plurality of virtual environments.

8. The network-wide service controller of claim 1, configured to optimize load balancing between computing resources of the at least one network by a result of performing path computation according to the state of the at least one network.

9. The network-wide service controller of claim 1, configured to provide a plurality of firewalls with different security requirements.

10. The network-wide service controller of claim 1, configured to provide a same firewall for a migrated virtual machine in the at least one network.

11. The network-wide service controller of claim 1, wherein the intelligent device is configured to coordinate distributed services over the at least one network according to a user request.

12. A network-wide service controller, comprising:
a processor;
a memory coupled to the processor;
wherein the memory storing an integrated set of instructions and the processor is configured to perform the integrated set of instructions for monitoring a state of at least one network, perform path computation according to the state of the at least one network, convert an instruction from a user into a lower-level instruction, analyze the lower-level instruction, and control forwarding of packets according to results of analysis of the lower-level instruction and the path computation.

13. The network-wide service controller of claim 11, wherein the integrated set of instructions is further configured to compose a service by combining processes according to a user request.

14. The network-wide service controller of claim 11, wherein the integrated set of instructions is further configured to build a plurality of virtual environments.

15. The network-wide service controller of claim 11, wherein the integrated set of instructions is further configured to deploy a load balancer between the plurality of virtual environments.

16. The network-wide service controller of claim 11, wherein the integrated set of instructions is further configured to optimize load balancing between computing resources of the at least one network by a result of performing path computation according to the state of the at least one network.

17. The network-wide service controller of claim 11, wherein the integrated set of instructions is further configured to provide a plurality of firewalls with different security requirements.

18. The network-wide service controller of claim 11, wherein the integrated set of instructions is further configured to provide a same firewall for a migrated virtual machine in the at least one network.

19. The network-wide service controller of claim 11, wherein the integrated set of instructions is further configured to coordinate distributed services over the at least one network.
